(19) United States
(12) Patent Application Publication
(10) Pub. No.: US 2010/0150230 A1
(43) Pub. Date: Jun. 17, 2010

(54) VIDEO CODING SYSTEM USING SUB-CHANNELS AND CONSTRAINED PREDICTION REFERENCES TO PROTECT AGAINST DATA TRANSMISSION ERRORS

(75) Inventors: Xiaosong ZHOU, San Jose, CA (US); Hsi-Jung WU, San Jose, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/337,273

(22) Filed: Dec. 17, 2008

(51) Int. Cl. H04N 7/32

(52) U.S. Cl. 375/240.12; 375/E07.246

(57) ABSTRACT

A coding technique is disclosed in which frames of a video sequence are assigned to one of a plurality of sub-channels to be transmitted to a decoder. The frames are coded according to predictive coding techniques such that ordinarily prediction references of the frames in each sub-channel only reach the reference frames that occur within the same sub-channel. Thus, if transmission errors arise with respect to one sub-channel, decoding may occur for other sub-channels until the transmission error is detected and corrected. The decoder may also try to reconstruct the frames in the failed sub-channel by interpolating from the frames in other channels. Furthermore, when feedback scheme is available between the encoder and decoder, the encoder may restart the failed sub-channel by coding the next frames in the sub-channel by predicting from correctly received frames in other sub-channels. And the encoder and decoder may resume normal encoding and decoding once the restart frame is sent and received, respectively. Additionally, the encoder and decoder can maintain an identical and correctly received long-term reference frame that can be used to restart all sub-channels in cases all sub-channels are corrupted at one point. The long-term reference frame can be refreshed periodically.

### BACKGROUND

The present invention relates to error mitigation techniques in video coding systems involving transmission through data networks.

Data errors are persistent problems in communication networks. To protect against transmission errors, it is common to encode data using error correction codes that permit a receiving entity to identify and correct some data corruption. While such techniques offer protection against some transmission errors, they do not solve all such problems.

Data transmission errors are particularly problematic in video coding systems. Video coders commonly achieve compression of video signals by exploiting temporal redundancy in video. Coders for example, predict data of one frame of video data using data of another frame that has coded previously and is known to both an encoder and a decoder. The first frame may be used to predict data of a second frame and the second frame may be used to predict data of a third frame. Such video coders can generate prediction chain across long sequences of video frames such that, if a single reference frame were lost due to a transmission error, a decoder not only would be unable to decode the lost frame but it also would be unable to decode any other frame that relied on the lost frame as a source of prediction. Thus, a transmission error that is very short—it corrupts a single reference frame—can have consequences that prevent decoding of many more frames in a coded video sequence.

No known system protects adequately against transmission errors that cause lost of reference frames from coded video data. Accordingly, there is a need in the art for a video coding system that provides increased protection against data errors and, particularly, one that permits at least partial decoding to continue even if a reference frame is lost.

### BRIEF DESCRIPTION OF THE DRAWINGS

FIG. 1 is a simplified block diagram of a video coding system according to an embodiment of the present invention.

FIG. 2 illustrates frame type assignments and prediction references that may occur in conventional coding systems.

FIG. 3 illustrates exemplary sub-channel assignments and prediction references that may occur during operation of the present invention.

FIG. 4 illustrates exemplary frame type assignments, prediction references and packet assignments that may occur during operation of the present invention.

FIG. 5 illustrates a method according to an embodiment of the present invention.

FIGS. 6 and 7 illustrate exemplary sub-channel packets and prediction references that may occur during operation of the present invention.

FIG. 8 illustrates another method according to an embodiment of the present invention.

FIG. 9 illustrates a further method according to an embodiment of the present invention.

FIG. 10 illustrates another method according to an embodiment of the present invention.

### DETAILED DESCRIPTION

Embodiments of the present invention provide a coding technique in which frames of a video sequence are assigned to one of a plurality of sub-channels to be transmitted to a decoder. The frames are coded according to predictive coding techniques such that ordinarily prediction references of the frames in each sub-channel only reach the reference frames that occur within the same sub-channel. Thus, if transmission errors arise with respect to one sub-channel, decoding may occur for other sub-channels before the transmission error is corrected.

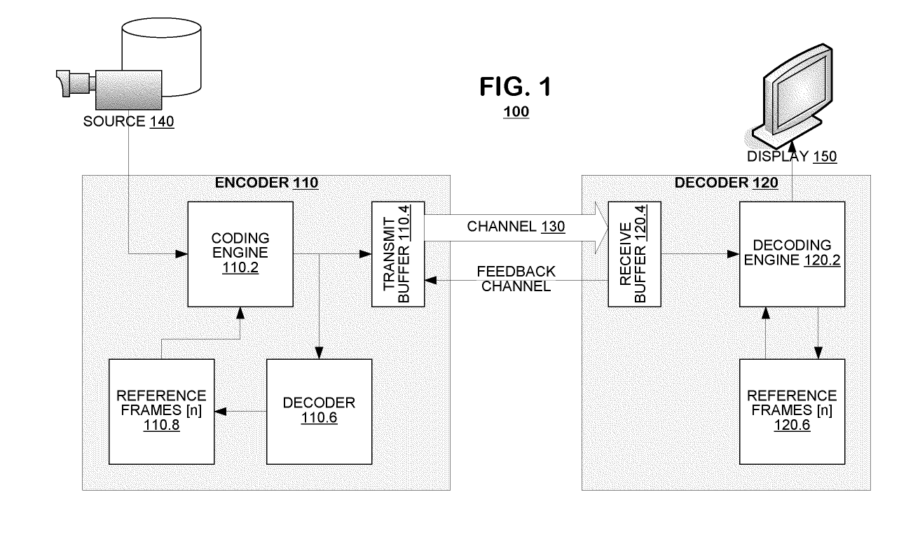

FIG. 1 illustrates a video coding system 100 according to an embodiment of the present invention. The system may include an encoder 110 and a decoder 120 provided in communication via a channel 130. The encoder 110 accepts source video from a source 140, for example a camera or a storage device, and codes the video data in a manner that reduces the bandwidth of the signal (e.g. compresses the source video). The encoder 110 delivers coded video data to the decoder 120. The decoder 120 decodes the coded video data in a manner that inverts the compression applied by the encoder 110. The decoder 120 generates recovered video data, which is a replica of the source video, which can be stored or displayed, for example via display device 150.

FIG. 1 provides a simplified block diagram of an encoder 110. The encoder may include a coding engine 110.2, which is a functional block that applies coding processes to the source video and generates coded video therefrom. A variety of coding processes are well known. They include the H.26x series of coding standards and the MPEG series of coding standards. Typically, such coding processes include data prediction, data transformation (e.g., DCT or wavelet transformation), quantization and entropy coding. Coded video data is stored may be stored in a transmit buffer 110.4 until the data can be scheduled for transmission to the decoder.

The encoder 110 also may include a decoder 110.6 which decodes the coded video data to derive the recovered video data that will be obtained by the decoder 120. Certain frames of recovered video data may be stored by the encoder 110 as reference frames (in buffer 110.8), which can be used by the coding engine 110.2 as sources of prediction for subsequent coding processes. In this regard, the operation of encoders is well known.

FIG. 1 also provides a simplified block diagram of a decoder 120. The decoder may include a decoding engine 120.2 that inverts the processes performed by the encoder's coding engine 110.2. The decoder also may include a receiver buffer 120.4 that stores received data until it can be scheduled for decoding by the decoding engine and a buffer 120.6 that may store decoded reference frames for use in subsequent decoding processes. For example, the H.264 standard includes protocols that support up to 16 reference frames concurrently. In this regard, the operation of decoders is well known.

The system of FIG. 1 may find application for us in network-based delivery systems in which coded video data is delivered to decoders 120 via a communication channel provided by the network. Coded data may be transmitted across a channel 130 of the network in datagrams, packets or other transmission units (called “packets” herein for ease of reference). The network also may support a feedback channel through which the decoder 120 may communicate with encoders 110 to acknowledge successful reception of transmitted packets or to identify transmitted packets that were not successfully received at the decoder. The architecture and organization of the network that supports the channel 130 is immaterial to the present discussion excepted as noted herein.

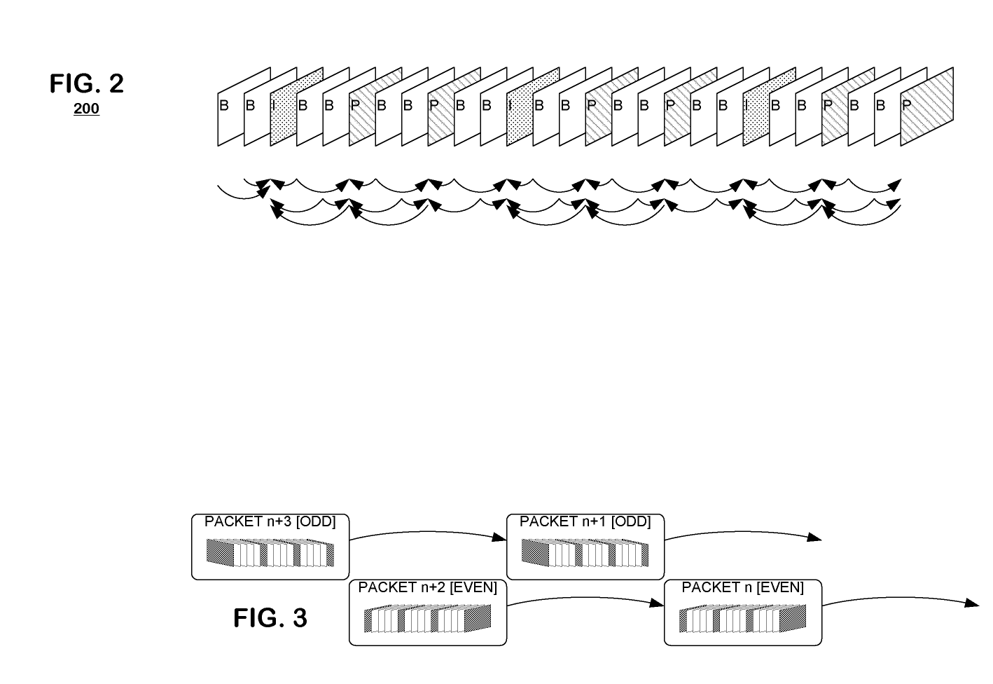

FIG. 2 illustrates an exemplary source video sequence and conventional predictive coding techniques that may be applied to them. The source video may include a sequence of video frames. During coding, each frame may be assigned a certain frame type, which can affect the coding techniques that are applied to the respective frame. For example, frames often are assigned to as one of the following frame types:
An Intra Frame (I frame) is one that its pixel blocks are coded and decoded without using any other frame in the sequence as a source of prediction,
A Predictive Frame (P frame) is one that its pixel blocks are coded and decoded using one other frame in the sequence as a source of prediction,
A Bidirectionally Predictive Frame (B frame) is one that its pixel blocks are coded and decoded using two other frames in the sequence as sources of prediction.
   Frames commonly are parsed spatially into a plurality of pixel blocks (for example, blocks of 4×4, 8×8 or 16×16 pixels each) and coded on a pixel block by pixel block basis. Predictive coding techniques may be performed on each pixel block of the frame. Based on the predictive coding that is applied to each frame, the coding process may define prediction chains among the frames in the video sequence, which are represented in FIG. 2 by arrows.

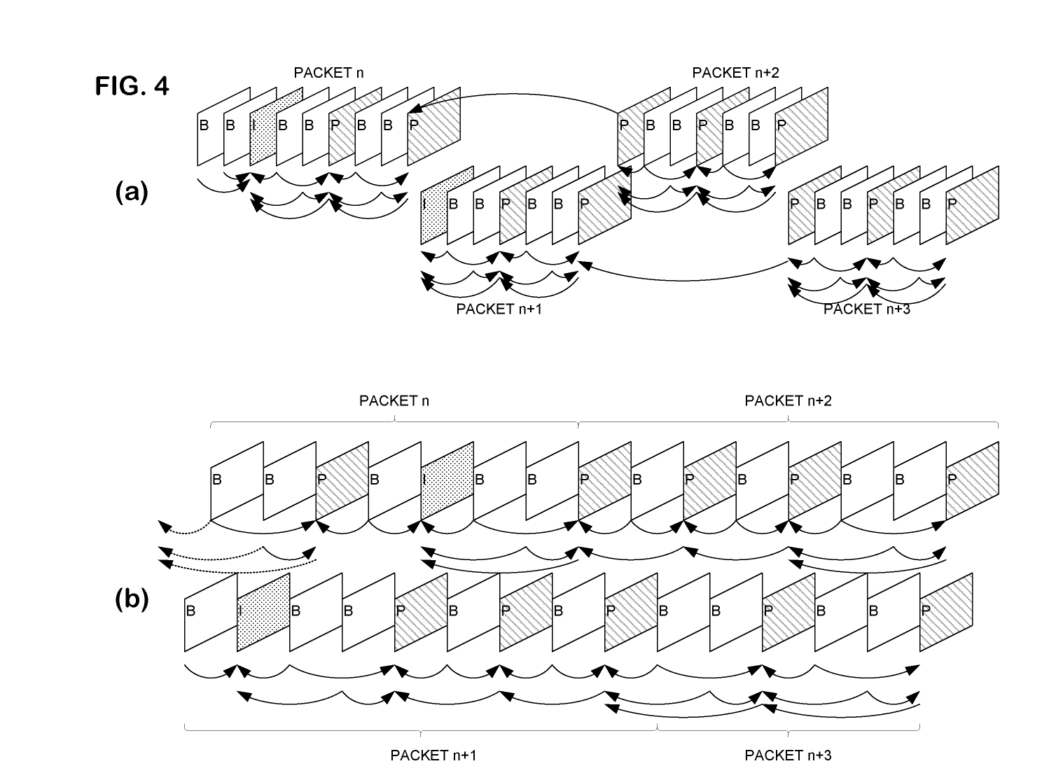

Embodiments of the present invention propose to develop a number of logical sub-channels within the transmission channel 130 established between an encoder 110 and a decoder 120. Better error resilience can be achieved when more sub-channels are used, as the error occurred in one sub-channel affects a smaller portion of the bit stream. However, compression efficiency may suffer with increased number of sub-channels. Therefore the number of sub-channels can be decided based on the transmission channel characteristics and can be changed during the process. For ease of reference, the scenario of using two sub-channels is illustrated and the sub-channels are termed the “even channel” and the “odd channel” respectively. FIGS. 3 and 4 illustrate relationships between transmitted packets and a coded video sequence, according to an embodiment of the present invention. As illustrated, packets may include coded video data of one or more frames of the video sequence. Packets may be generated sequentially and alternately assigned to the odd or even channels. In this embodiment, during normal operation prediction references of coded frames are constrained to refer to references frames that appear in the same sub-channel as the coded frame. In other words, a coded frame that is assigned to the even sub-channel may refer only to a reference frame that also is assigned to the even sub-channel and a coded frame that is assigned to the odd sub-channel may refer only to a reference frame that also is assigned to the odd sub-channel. A coded frame may rely on a reference frame from the same packet as the coded frame or on a reference frame that is in a different packet as the coded frame. FIG. 4, for example, shows both inter-packet prediction references and intra-packet prediction references.

Frames may be assigned to packets according to a variety of schemes. FIG. 4(a) illustrates an example where coded data of a sequence of consecutive frames are assigned to each packet. FIG. 4(b) illustrates another example where frames are assigned to odd and even sub-channels in an alternating fashion.

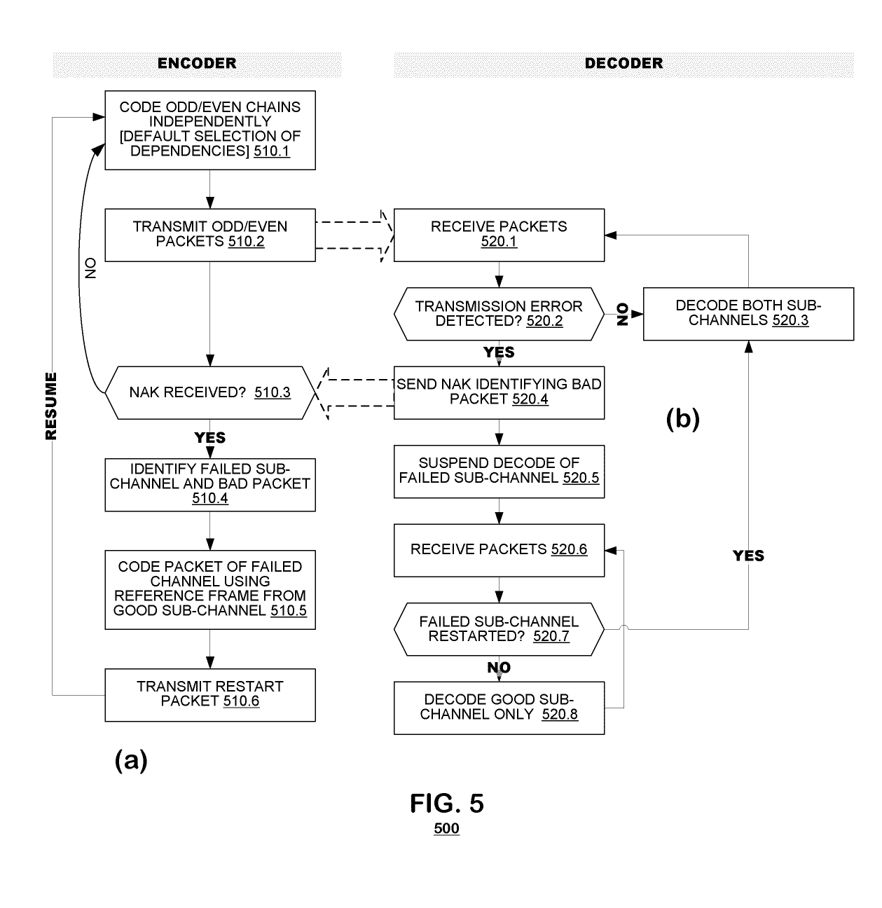

FIG. 5 is a flow diagram illustrating a method of operation of encoders and decoders according to an embodiment of the present invention. Boxes 510.1-510.2 represent operation of an encoder during a normal mode of operation. As such, the encoder may code frames belonging to the even sub-channels and the odd sub-channels independently of each other (box 510.1). In this normal mode, prediction references for a given frame are constrained to reach only those reference frames that occur within the same sub-channel as the frame being coded. Thereafter, the transmitter may transmit odd and even packets to a decoder (box 510.2).

Boxes 520.1-520.3 represent operation of a decoder according to normal operation. The decoder may receive transmitted packets from an encoder (box 520.1) and determine whether transmission errors have occurred with respect to the received packets (520.2). If not, if the packets are well received, the decoder may decode the packets from both sub-channels (box 520.3) and generate a recovered video sequence therefrom. This operation may continue indefinitely until the video sequence is fully processed or until a transmission error is detected.

If the decoder detects a transmission error, the decoder may identify the bad packet and transmit an identifier of the bad packet back to the encoder via the back channel (box 520.4). Colloquially, the decoder may send a negative acknowledgement to the encoder (or “NAK”). The decoder may identify the sub-channel—odd or even—to which the bad packet belongs and treat the identified sub-channel as a “failed sub-channel.” The decoder may suspend decoding of packets belonging to the failed sub-channel but continue decoding of packets belonging to the other sub-channel (the “good sub-channel”) (box 520.5).

At the encoder, if the encoder receives a negative acknowledgement (box 510.3), the encoder may identify the bad packet and the sub-channel that has failed (box 510.4). The encoder may code one or more frames of the failed sub-channel using reference frame(s) from the good sub-channel (box 510.5). The packet generated in box 510.5 may be termed a “restart” packet. The encoder may transmit the restart packet to the decoder in the failed sub-channel (box 510.6). Thereafter, the encoder may resume normal operation (boxes 510.1-510.2).

At the decoder, once it suspends decoding of the failed sub-channel, the decoder may continue to receive packets and decode coded video data contained in the good sub-channel (box 520.6, 520.8). The decoder also may examine packets of the failed sub-channel to determine if the sub-channel contains a restart packet (box 520.7). If not, the decoder continues to decode the good sub-channel only (box 520.8). Eventually, however, it is expected the decoder will receive the restart packet. Once it does, the decoder should have sufficient information on which to decode both sub-channels and, therefore, it may revert to normal operation (boxes 520.1-520.3).

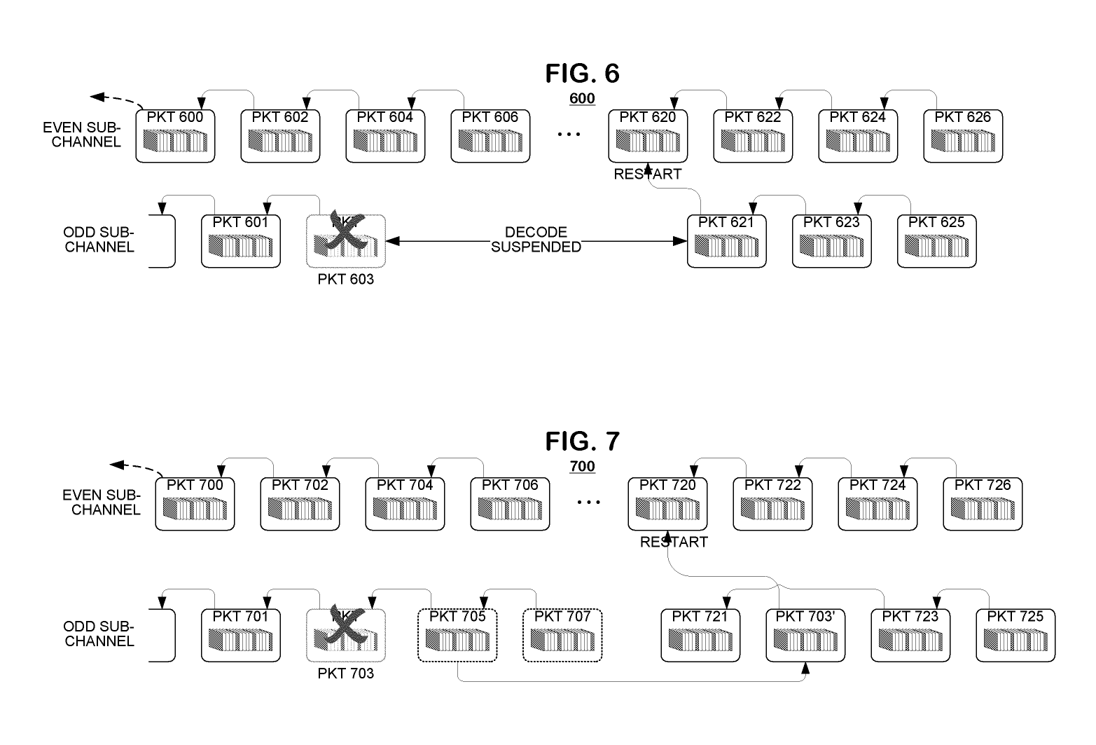

FIG. 6 illustrates an exemplary packet sequence that may occur during operation of the foregoing method and its effect on decoding processes. In this example, packets 600-603 are created for both the even and odd channels in the normal mode. The packets contain prediction references that are constrained to refer only to reference frames of a common sub-channel.

In this example, packet 603 is received with a transmission error that renders it unusable. In response, a decoder may suspend decode of the sub-channel in which it occurs (the odd sub-channel in the example of FIG. 6). Packets of the even sub-channel may be received and decoded so as to generate a useful recovered video signal.

Packet 621 is shown as a restart packet. Packet 621 may contain coded video data that refer to frames of packet 620 as reference frames for prediction. In this case, the decoder may detect the presence of a restart packet, decode the frames contained therein and resume normal operation for subsequently received packets in the failed sub-channel (e.g., packets 623-625, etc.).

The principles of the present invention find application in a wide variety of communication networks. Given the variety of networks in which these embodiments may be used, there can be wide variation in the round trip latency that may occur from the time that a given packet is transmitted by the encoder to the time that the packet is detected as having a transmission error by the decoder and the time that the encoder receives a negative acknowledgement of the packet. In some embodiments, if the round trip latency is large enough that it is unlikely the decoder would be able to receive a new copy of the failed packet and reconstruct packets of the failed sub-channel that were coded after the failed packet but before the encoder received the negative acknowledgement (say packets 605-619 in the example of FIG. 6), the encoder may code a next packet 621 in sequence and use a nearby packet from the good sub-channel as a reference.

In other network implementations for which the round trip latency is sufficiently short, an encoder may attempt to recode the failed packet. This embodiment is shown in FIG. 7. In this example, if packet 703 is identified as a failed packet, the encoder may attempt to recode the packet (as 703′) using frames from the good sub-channel as reference frames. In this embodiment, a decoder may retain received packets 705-721 etc. that follow the failed packet in the receive buffer and may attempt to decode them upon receive of the recoded packet 703′. If the display requirements of the decoder provide sufficient time for the decoder to await a recoded packet 703′ and then decode the recoded packet 703′ as well as the retained packets 705-721, this embodiment may eliminate display errors that otherwise would have been caused by lost frames in the failed sub-channel.

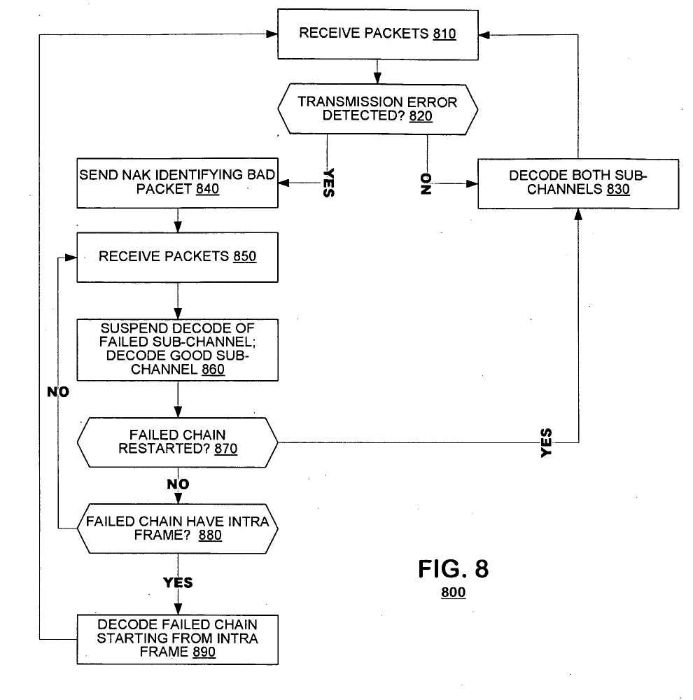

FIG. 8 illustrates another decoder method 800 according to an embodiment of the present invention. In this embodiment, the normal mode of operation may occur as in the embodiment of FIG. 5. That is, the decoder may receive packets, determine whether the packets contain transmission errors and, so long as there are no errors, decode coded video data from both sub-channels (boxes 810-830).

If a transmission error occurs, the decoder may send a negative acknowledgement identifying the bad packet to the decoder (box 840). The decoder may continue to receive packets (box 850) and decode the good sub-channel but it may suspend decode of the failed sub-channel (box 860). The decoder may continue to monitor the failed sub-channel to determine if the encoder has restarted the sub-channel (box 870). If so, the decoder may resume normal operation. Even if not, the decoder may determine whether a received packet in the failed sub-channel contains an I frame (box 880). If so, the I frame can be decoded (box 890); it does not refer to any other frame as a source of prediction. Moreover, any frame in the failed sub-channel that refers to the I frame as a source of prediction also may be decoded.

Conventionally, I frames are used in video coding to support random access functionality. By decoding an I frame, the decoder may recover from a sub-channel failure before receiving a restart packet.

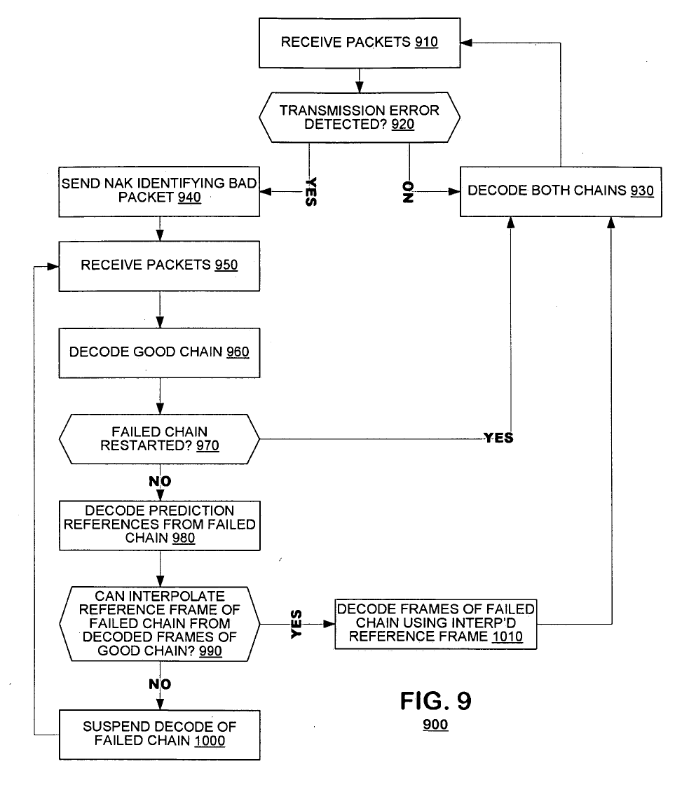

FIG. 9 illustrates another decoder method according to an embodiment of the present invention. In this embodiment, the normal mode of operation also may occur as in the embodiment of FIG. 5. That is, the decoder may receive packets, determine whether the packets contain transmission errors and, so long as there are no errors, decode coded video data from both sub-channels (boxes 910-930).

If a transmission error occurs, the decoder may send a negative acknowledgement identifying the bad packet to the decoder (box 940). The decoder may continue to receive packets (box 950) and decode the good sub-channel but it may suspend decode of the failed sub-channel (box 960). The decoder may continue to monitor the failed sub-channel to determine if the encoder has restarted the sub-channel (box 970). If so, the decoder may resume normal operation.

Even if the failed sub-channel has not been started, the decoder may examine packets of the failed channel to identify the position of reference frames in display order (box 980). The decoder may attempt to interpolate content of the reference frames from recovered video data obtained from the good sub-channel (box 990). For example, if frames are assigned to odd and even sub-channels in an alternating fashion (see, FIG. 4(b)), a decoder may able to decode video content of two frames that are adjacent to each missing reference frame using the coded data from the good sub-channel. If the decoded frames are similar to each other within a predetermined level of variation, the decoder may interpolate content of the missing reference frame within a high level of confidence. Having done so, the decoder may decode subsequently received packets using the interpolated reference frame as a source of prediction for the frames in the subsequently received packets of the failed sub-channel (box 1010). Thereafter, the decoder may resume normal operation. If, however, the decoder cannot interpolate content of the missing reference frames with a sufficient level of confidence, the decoder may continue decoding only the coded video data present in the good sub-channel (box 1000).

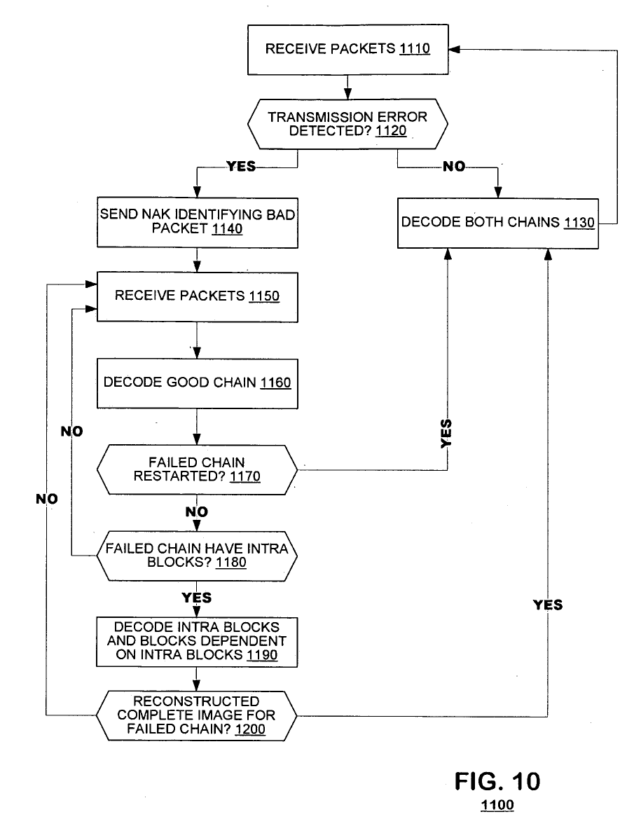

FIG. 10 illustrates another decoder method according to a further embodiment of the present invention. In this embodiment, the normal mode of operation also may occur as in the embodiment of FIG. 5. That is, the decoder may receive packets, determine whether the packets contain transmission errors and, so long as there are no errors, decode coded video data from both sub-channels (boxes 1110-1130).

If a transmission error occurs, the decoder may send a negative acknowledgement identifying the bad packet to the decoder (box 1140). The decoder may continue to receive packets (box 1150) and decode the good sub-channel but it may suspend decode of the failed sub-channel (box 1160). The decoder may continue to monitor the failed sub-channel to determine if the encoder has restarted the sub-channel (box 1170). If so, the decoder may resume normal operation.

Even if the failed sub-channel has not been started, the decoder may examine packets of the failed channel to identify intra coded pixel blocks contained therein (box 1180). Intra coded pixel blocks can appear in any frame type (I frames, P frames or B frames); the intra coded pixel blocks can be decoded without reference to any other block. If such pixel blocks are found, the system may decode the intra coded blocks and any pixel blocks of other frames that depend on the intra coded blocks (box 1190). The decoder further may determine whether a sufficient number of intra coded blocks and their dependents have been decoded to render a complete image (box 1200). If so, the decoder may use the completed image to restart the failed sub-channel. If not, the decoder may continue operation with decoding of the failed sub-channel being suspended.

The embodiment of FIG. 10 may find application in certain coding environments where intra coded frames appear frequently in the coded video data. The intra coded blocks may be introduced to the coded video data as an effort to apply a gradual refresh to the video data but avoid the costs associated with full I frames, which tend to be very large as compared to P or B frames. In such an embodiment, the decoder may use the intra coded pixel blocks to “fill in” various spaces of the video data. Eventually, the decoder may receive a sufficient number of intra coded pixel blocks to cover the spatial area of the video image. The decoder may use the recovered image as a reference frame for decoding of subsequent frames.

Of course, the embodiments of FIG. 9 and FIG. 10 may be used cooperatively. That is, the decoder may interpolate data for a reference frame to facilitate a fast but coarse restart of the failed sub-channel but use received intra coded pixel blocks to improve the restarted reference image. Such techniques permit use of the FIG. 9 embodiment in circumstances where a decoder cannot confidently interpolate content of a reference frame and, therefore, decode artifacts may arise. The embodiment of FIG. 10 may use the intra coded pixel block to correct such artifacts quickly.

As shown in the foregoing discussion, the techniques of the prior embodiments protect system operation when transmission errors are confined to some of the sub-channels within a period of time corresponding to a roundtrip communication times between a video coder and a video decoder. When long bursty errors occur in the network and cause all subsequences to be corrupted, system operation may be compromise. According to another embodiment, to protect against longer errors, a system may employ a backup long-term reference frame. A backup reference frame is a reference frame that is stored both at an encoder and a decoder for use in predictive video coding. By coding protocols, an encoder may designate a given coded frame as a long term reference frame which is stored by the decoder for decoding of other frames.

According to an embodiment, the coding protocols may be enhanced to require a decoder to acknowledge successful receipt of a long term reference frame back to the encoder and to store the long term reference frame until a subsequently-received long term reference frame is successfully received and acknowledged. Accordingly, there will always exist a long term reference frame that is “known” to both the encoder and the decoders. If an error condition arises that corrupts all sub-channels, the encoder may resume coding of a video sequence with reference to the long term reference frame that is known to be stored in uncorrupted form at the decoder. This technique further contributes to system resilience in the presence of coding errors.

The foregoing discussion has described operation of the embodiments of the present invention in the context of encoders and decoders. Commonly, video encoders are provided as electronic devices. They can be embodied in integrated circuits, such as application specific integrated circuits, field programmable gate arrays and/or digital signal processors. Alternatively, they can be embodied in computer programs that execute on personal computers, notebook computers or computer servers. Similarly, decoders can be embodied in integrated circuits, such as application specific integrated circuits, field programmable gate arrays and/or digital signal processors, or they can be embodied in computer programs that execute on personal computers, notebook computers or computer servers. Decoders commonly are packaged in consumer electronics devices, such as gaming systems, DVD players, portable media players and the like and they also can be packaged in consumer software applications such as video games, browser-based media players and the like.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A video coding method comprising:
assigning frames of a video sequence to one of a plurality of sub-channels to be transmitted to a decoder,
coding content of the video sequence according to predictive coding techniques wherein, during normal operation, prediction references of the coded frames in each sub-channel reach only to reference frame(s) that are located within the same sub-channel to which the respective coded frame has been assigned, and
transmitting the coded frames to a decoder in packets, each packet containing a plurality of frames assigned to a common sub-channel.

2. The video coding method of claim 1, further comprising, during a transmission recovery mode, coding select frames belonging to a first, failed sub-channel using reference frames from a second, good channel as a source of prediction.

3. The video coding method of claim 2, wherein the transmission recovery mode is engaged in response to a negative acknowledgement received from the decoder.

4. The video coding method of claim 2, further comprising:
transmitting the coded select frame in a single restart packet and,
after transmission of the single restart packet, coding subsequent frames of the failed sub-channel according to the normal operation.

5. The video coding method of claim 1, further comprising, during a transmission recovery mode, when a plurality of sub-channels have been corrupted, predictively coding frames of the video sequence using a reference frame as a source of prediction, the reference frame known to be successfully received by a decoder.

6. The video coding method of claim 5, further comprising
storing the known good reference frame as a first long term reference frame until an acknowledgment is received from the decoder that a second long term reference frame has been successfully received, and
after the acknowledgment is received, replacing the first long term reference frame with a second long term reference frame.

7. A video coder, comprising:
a coding engine to code frames of a source video sequence according to predictive coding techniques,
a transmission unit to transmit coded frames to a decoder in sub-channels,
wherein, in a normal mode of operation, the coding engine generates prediction references of the coded frames in each sub-channel that reach only to reference frame(s) that are located within the same sub-channel to which the respective coded frame has been assigned.

8. The video coder of claim 7, wherein, in a transmission recovery mode of operation, the coding engine codes select frames belonging to a first, failed sub-channel using reference frames from a second, good channel as a source of prediction.

9. The video coder of claim 8, wherein the video coder engages the transmission recovery mode in response to a negative acknowledgement received from the decoder.

10. The video coder of claim 8, wherein the video coder:
transmits the coded select frame in a single restart packet and,
after transmission of the single restart packet, codes subsequent frames of the failed sub-channel according to the normal mode of operation.

11. A video decoding method, comprising:
receiving packets of data containing coded video data, each packet belonging to one of a plurality of sub-channels,
in a normal mode of operation when no packet reception errors are detected, decoding coded video data of each packet, the decoding including, for each sub-channel, prediction references to be followed from coded frames to reference frames that are located in the respective sub-channel,
when a transmission error is detected, suspending decode of a sub-channel for which a failure has occurred detected but continuing the decoding with respect to another sub-channel for which no failure has occurred.

12. The method of claim 11, further comprising transmitting a negative acknowledgement to an encoder identifying a packet for which the transmission error has occurred.

13. The method of claim 11, further comprising when a restart packet is received in the failed sub-channel, resuming decode of the failed sub-channel, wherein:
decoding of the restart packet requires prediction references to be followed from coded frames therein to reference frames of the sub-channel for which no failure has occurred,
decoding of packets subsequent to the restart packet requires prediction references to be followed from coded frames therein to references frames of the failed sub-channel.

14. The method of claim 13, further comprising, if the restart packet is a recoded version of a packet for which the transmission error has occurred, decoding packets received between the erroneous packet and the restart packet.

15. The method of claim 11, further comprising:
determining if received packets of the failed sub-channel include an intra coded frame, and
if received packets of the failed sub-channel include an intra coded frame, resuming normal decoding of the failed sub-channel starting with the intra coded frame.

16. The method of claim 11, further comprising, for packets of the failed sub-channel received after the transmission error is detected:
identifying display positions of reference frames referenced by coded video data in the subsequently received packets,
interpolating data of reference frames at the identified display positions from recovered video data generated from the other sub-channel,
assigning a level of confidence to the interpolated data, and
if the level of confidence exceeds a predetermined threshold, resuming normal decoding of the failed sub-channel starting with the interpolated reference frame data.

17. The method of claim 11, further comprising, for packets of the failed sub-channel received after the transmission error is detected:
identifying intra coded pixel blocks within the coded video data of the subsequently received packets,
on an ongoing basis, decoding the intra coded pixel blocks and other pixel blocks that refer to the intra coded pixel blocks as sources of prediction,
when the decoded pixel block are sufficient to reconstruct a complete video image, resuming normal decoding of the failed sub-channel starting with the complete video image.

18. A video decoding method, comprising:
receiving packets of data containing coded video data, each packet belonging to one of a plurality of sub-channels,
in a normal mode of operation when no packet reception errors are detected, decoding coded video data of each packet, the decoding including, for each sub-channel, prediction references to be followed from coded frames to reference frames that are located in the respective sub-channel,
when a transmission error is detected in which a plurality of sub-channels have been corrupted,
suspending decoding of data thereafter received in the sub-channels under new coded data is received that identifies a long term reference frame as a source of prediction for the new data,
decoding the new coded data with reference to the long term reference frame and
thereafter, resuming the normal mode of operation.

19. The video decoding method of claim 18, further comprising
when a new long term reference frame is received in the coded video data,
decoding the new long term reference frame, and
if the new long term reference frame is successfully decoded, transmitting an acknowledgement to the encoder, and
storing the new long term reference frame in memory until another long term reference frame is received, successfully decoded and acknowledged.

20. A video decoder, comprising:
a decoding engine to decode code video data according to predictive coding techniques,
a reception unit to receive coded video data in sub-channels,
wherein, in a normal mode of operation, the decoding engine generates recovered video data according to prediction references of coded frames that reach only to reference frame(s) located within the same sub-channel in which the respective coded frame is received.

21. The video decoder of claim 20, wherein a transmission error is detected, the video decoder suspends decode of a sub-channel for which a failure has occurred detected but continues decoding another sub-channel for which no failure has occurred.

22. The video decoder of claim 21, wherein the decoder transmits a negative acknowledgement to an encoder identifying a packet for which the transmission error has occurred.

23. The video decoder of claim 21, wherein the decoder, when a restart packet is received in the failed sub-channel, resumes decode of the failed sub-channel, wherein:
when processing the restart packet, the decoding engine generates recovered video data according to prediction references from coded frames therein to reference frames of the sub-channel for which no failure has occurred,
the decoding engine decodes of packets subsequent to the restart packet according to the normal mode of operation.

24. The video decoder of claim 23, wherein, if the restart packet is a recoded version of a packet for which the transmission error has occurred, the decoding engine decodes packets received between the erroneous packet and the restart packet.

25. The video decoder of claim 21, wherein the video coder:
determines if received packets of the failed sub-channel include an intra coded frame, and
if received packets of the failed sub-channel include an intra coded frame, resumes normal decoding of the failed sub-channel starting with the intra coded frame.

26. The video decoder of claim 21, wherein, for packets of the failed sub-channel received after the transmission error is detected, the video coder:
identifies display positions of reference frames referenced by coded video data in the subsequently received packets,
interpolates data of reference frames at the identified display positions from recovered video data generated from the other sub-channel,
assigns a level of confidence to the interpolated data, and
if the level of confidence exceeds a predetermined threshold, resumes normal decoding of the failed sub-channel starting with the interpolated reference frame data.

27. The video decoder of claim 21, wherein, for packets of the failed sub-channel received after the transmission error is detected, the video coder:
identifies intra coded pixel blocks within the coded video data of the subsequently received packets,
on an ongoing basis, decodes the intra coded pixel blocks and other pixel blocks that refer to the intra coded pixel blocks as sources of prediction,
when the decoded pixel block are sufficient to reconstruct a complete video image, resumes normal decoding of the failed sub-channel starting with the complete video image.
